(19) United States
(12) Patent Application Publication
(10) Pub. No.: US 2026/0167827 A1
(43) Pub. Date: Jun. 18, 2026

(54) TWO-DIMENSIONAL PARTICLE, TWO-DIMENSIONAL PARTICLE-CONTAINING DISPERSION LIQUID, TWO-DIMENSIONAL PARTICLE-CONTAINING COMPOSITE, TWO-DIMENSIONAL PARTICLE-CONTAINING FILM, AND TWO-DIMENSIONAL PARTICLE PRODUCTION METHOD

(71) Applicant: Murata Manufacturing Co., Ltd., Nagaokakyo-shi (JP)

(72) Inventor: Masaki YAMAMOTO, Nagaokakyo-shi (JP)

(21) Appl. No.: 19/529,639

(22) Filed: Feb. 4, 2026

Related U.S. Application Data
(63) Continuation of application No. PCT/JP2024/028266, filed on Aug. 7, 2024.

(30) Foreign Application Priority Data
Aug. 10, 2023 (JP) 2023-131268

(51) Int. Cl. C09C 1/36; C08K 9/04; C09C 3/08

(52) U.S. Cl. CPC C09C 1/36; C08K 9/04; C09C 3/08; C01P 2002/77; C01P 2002/84; C01P 2002/88; C01P 2004/24; C08K 2201/001; C08K 2201/011

(57) ABSTRACT

A two-dimensional particle comprising a single layer or multiple layers, wherein the single layer or multiple layers each include: a layer body represented by: MₘXₙ wherein M is one or more metal of Group 3, 4, 5, 6, or 7, X is a carbon atom, a nitrogen atom, or a combination thereof, n is 1 to 4, and m is more than n but not more than 5; and a modifier or terminal T exists on a surface of the layer body, wherein the two-dimensional particle has a structure in which an M atom of the layer body and a heteroatom of a heteroatom-containing compound are covalently bonded or ionically bonded together via an oxygen atom derived from a hydroxy group of the layer body, and a substitution rate of hydroxy groups existing on the surface of the layer body to the structure is 37.5% or more.

### CROSS REFERENCE TO RELATED APPLICATIONS

The present application is a continuation of International application No. PCT/JP2024/028266, filed Aug. 7, 2024, which claims priority to Japanese Patent Application No. 2023-131268, filed Aug. 10, 2023, the entire contents of each of which are incorporated herein by reference.

### TECHNICAL FIELD

The present disclosure relates to a two-dimensional particle, a two-dimensional particle-containing dispersion liquid, a two-dimensional particle-containing composite, a two-dimensional particle-containing film, and a method for producing a two-dimensional particle.

### BACKGROUND ART

In recent years, MXene has been attracting attention as a new material. MXene is a type of so-called two-dimensional material, and is a layered material in the form of a single layer or multiple layers. In detail, MXene is a layered compound represented by a composition of MₘXₙTₛ, and is obtained by etching MAX, which is a precursor. Due to the etching of MAX, modifiers or terminals such as —OH, ═O, and —F are generated on a surface of MXene. The modifiers or terminals impart hydrophilic properties to MXene. Therefore, MXene has excellent water dispersion characteristics. MXene also exhibits excellent conductivity.

However, there is a problem that MXene dispersed in water is easily oxidized by water molecules and dissolved oxygen to be changed to a metal oxide (titanium oxide), and original excellent characteristics are lost. In addition, since MXene has a hydrophilic surface, there is a problem that MXene has a low attractive force with a hydrophobic material (polymers, organic solvents, etc.), and it is difficult to form a homogeneous composite material by mixing MXene with such a hydrophobic material. Furthermore, there is also a problem that when a MXene film is formed in a liquid process such as spray coating, high energy needs to be consumed to remove water.

In view of the above problem, Patent Document 1 discloses a passivated two-dimensional MXene particle, comprising: a two-dimensional MXene particle surface-modified with a functional group comprising a saturated or unsaturated hydrocarbon; and an organic protective film formed on the surface of the surface-modified two-dimensional MXene particle, wherein the functional group is selected from the group consisting of a phosphonate and an amine, and the two-dimensional MXene particle surface-modified with a functional group containing a saturated or unsaturated hydrocarbon is dispersed in an organic solvent forming the protective film. Patent Document 1 discloses that the two-dimensional MXene particle is easily dispersed in an organic solvent, and not only the production of a polymer composite containing the particle is easy, but also the two-dimensional MXene particle has advantageous characteristics for the application of films and coating products having various performances.

In addition, Non-patent Document 1 discloses that, for example, for the purpose of realizing a stretchable electrode, a Ti₃C₂Tₓ MXene dispersion liquid stable in an organic solvent is prepared for mixing with a non-polar polymer matrix soluble in an organic medium. Specifically, Ti₃C₂Tₓ flakes with an alkylphosphonic acid (R—P(═O)(OH)₂ adsorbed on the surface thereof are disclosed. The Ti₃C₂Tₓ flakes are prepared by etching Ti₃AlC₂ using an etching liquid in which LiF is dissolved in HCl, and —F, —Cl, —O, and —OH exist on the surface of Ti₃C₂.
Patent Document 1: JP 2020-93971 A
Non-patent Document 1: Nonpolar Organic Dispersion of 2D Ti3C2Tx MXene Flakes via Simultaneous Interfacial Chemical Grafting and Phase Transfer Method. ACS Nano 2019, 13, 12, 13818-13828

### SUMMARY OF THE DISCLOSURE

The MXene particles of Patent Document 1 and Non-patent Document 1 can be dispersed only in an organic dispersion medium (solubility in water <10% w/w) that does not mix with water, and there is a limitation on an organic dispersion medium in which the MXene particles can be dispersed. In addition, the MXene particles of Patent Document 1 and Non-patent Document 1 have a problem of low dispersion stability in an organic dispersion medium. The present disclosure has been made in view of the above circumstances, and an object thereof is to provide a two-dimensional particle which can be dispersed in various organic dispersion media and has high dispersion stability in a dispersion liquid, a two-dimensional particle-containing dispersion liquid, a two-dimensional particle-containing composite, and a two-dimensional particle-containing film each containing the two-dimensional particle, and a method for producing the two-dimensional particle.

According to one gist of the present disclosure, there is provided a two-dimensional particle comprising a single layer or multiple layers, wherein the single layer or multiple layers each include:
a layer body represented by the following formula:

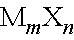

wherein M is one or more metal of Group 3, 4, 5, 6, or 7,
X is a carbon atom, a nitrogen atom, or a combination thereof,
n is not less than 1 and not more than 4, and
m is more than n but not more than 5; and
a modifier or terminal T existing on a surface of the layer body, wherein the T is one or more selected from the group consisting of a hydroxy group, a fluorine atom, a chlorine atom, an oxygen atom, and a hydrogen atom,
the two-dimensional particle has a structure in which an M atom of the layer body and a heteroatom of a heteroatom-containing compound having a saturated hydrocarbon group or an unsaturated hydrocarbon group are covalently bonded or ionically bonded together via an oxygen atom derived from a hydroxy group of the layer body, and
a substitution rate of hydroxy groups existing on the surface of the layer body to the structure is 37.5% or more.

According to the present disclosure, it is possible to provide a two-dimensional particle which can be dispersed in various organic dispersion media and has high dispersion stability in a dispersion liquid, a two-dimensional particle-containing dispersion liquid, a two-dimensional particle-containing composite, and a two-dimensional particle-containing film each containing the two-dimensional particle, and a method for producing the two-dimensional particle.

### BRIEF DESCRIPTION OF THE DRAWINGS

FIGS. 1(a) and 1(b) are schematic cross-sectional views for explaining MXene constituting a two-dimensional particle of the present embodiment (or a precursor particle to be used for the production of a two-dimensional particle of the present embodiment), in which FIG. 1(a) illustrates a single-layer MXene, and FIG. 1(b) illustrates a multilayer (exemplarily, two-layer) MXene.

FIG. 2 is a diagram showing a weight change of the ligand-substituted MXene particle in Example 1-1 measured by differential thermal analysis.

FIG. 3 is a diagram explaining preconditions for calculating a ligand coverage.

FIG. 4 is a diagram showing an ultraviolet-visible spectrophotometric measurement result (ultraviolet-visible absorption spectrum) in Example 1-1.

FIG. 5 is a diagram showing ultraviolet-visible spectrophotometric measurement results (ultraviolet-visible absorption spectrum) for different standing times in Example 1-1.

FIG. 6 is a diagram showing the relationship between the standing time and the ratio of the absorbance to the initial absorbance (indicated as “absorbance (after normalization)” in FIG. 6) in Example 1-1.

FIG. 7 is a diagram showing the relationship between the ligand coverage and the dispersion stability in Example 1.

FIG. 8 is a diagram showing the relationship between the ligand coverage and the conductivity of a ligand-substituted MXene film in Example 2.

### DETAILED DESCRIPTION OF THE PREFERRED EMBODIMENTS

There is a demand for a two-dimensional particle containing MXene and dispersible in various organic dispersion media. However, as described above, the MXene particles of Patent Document 1 and Non-patent Document 1 have a problem that the organic dispersion medium in which the MXene particles can be dispersed is limited and the dispersion stability in the organic dispersion medium is low. The present inventor has conducted studies on this problem, and have first found that the methods for producing MXene particles in Patent Document 1 and Non-patent Document 1 cause the above problem. In the production methods of Patent Document 1 and Non-patent Document 1, it is necessary to lower the pH (to about 2.5) by adding hydrochloric acid to the aqueous dispersion liquid in which a MXene particle is dispersed before a substitution reaction. This is intended to increase the reaction rate of the phase separation type interface reaction by protonating hydroxy groups on MXene. However, under a strong acid condition of about pH 2.5, MXene aggregates to form MXene aggregates. This is considered to be because the zeta potential of MXene changes from negative to around 0, and electrostatic repulsion between flakes disappears. It is considered that when a MXene aggregate is formed before the substitution reaction, in the substitution reaction, hydroxy groups existing on the surface of the MXene layer body undergo substitution (hereinafter, sometimes referred to as a “ligand substitution”) with a heteroatom-containing compound having a saturated hydrocarbon group or an unsaturated hydrocarbon group (hereinafter, sometimes referred to as a “ligand”) only around the MXene aggregate, so that the substitution rate of the hydroxy groups existing on the surface of the layer body with the heteroatom-containing compound (hereinafter, sometimes referred to as a “ligand coverage”) decreases. A low ligand coverage means that hydrophobization by surface modification of MXene is insufficient, and as a result, it is considered that dispersion stability in an organic dispersion medium is low.

Then, as a result of intensive studies, the present inventor has found that to solve the above problems, it is necessary to conduct ligand substitution on each MXene particle (for example, a single-layer or few-layer MXene flake) without forming an aggregate of MXene particles in the step of producing MXene particles, thereby improving the ligand coverage, and for this purpose, it is necessary to conduct ligand substitution without bringing the aqueous dispersion liquid in which MXene particles are dispersed into an acidic state at the stage before the substitution reaction.

Hereinafter, each of the two-dimensional particle, the two-dimensional particle-containing dispersion liquid, the two-dimensional particle-containing composite, the two-dimensional particle-containing film, and the method for producing a two-dimensional particle according to the present disclosure will be described.

### Embodiment 1: Two-Dimensional Particle

Hereinafter, the two-dimensional particle according to one embodiment of the present disclosure will be described in detail, but the present disclosure is not limited to such an embodiment.

A two-dimensional particle in the present embodiment is a two-dimensional particle comprising a single layer or multiple layers, wherein the layer or layers each includes:
a layer body represented by the following formula:

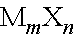

wherein M is one or more metal of Group 3, 4, 5, 6, or 7,
X is a carbon atom, a nitrogen atom, or a combination thereof,
n is not less than 1 and not more than 4, and
m is more than n but not more than 5; and
a modifier or terminal T existing on a surface of the layer body, wherein the T is one or more selected from the group consisting of a hydroxy group, a fluorine atom, a chlorine atom, an oxygen atom, and a hydrogen atom,
the two-dimensional particle has a structure in which an M atom of the layer body and a heteroatom of a heteroatom-containing compound having a saturated hydrocarbon group or an unsaturated hydrocarbon group are covalently bonded or ionically bonded together via an oxygen atom derived from a hydroxy group of the layer body, and
a substitution rate of hydroxy groups existing on the surface of the layer body to the structure is 37.5% or more. The two-dimensional particle in the present embodiment has a high substitution rate of a plurality of hydroxy groups existing on the surface of the layer body to the phosphoric acid compound, in other words, has many structures in which an M atom of the layer body and a heteroatom of a heteroatom-containing compound having a saturated hydrocarbon group or an unsaturated hydrocarbon group are covalently bonded or ionically bonded together via an oxygen atom derived from a hydroxy group of the layer body. Thus, the two-dimensional particle in the present embodiment is excellent in dispersion stability in an organic dispersion medium.

In the present description, when an “atom” is mentioned for a certain element, the oxidation number of the element is not limited to 0, and may be any number within the range of the oxidation number that can be taken by the element.

First, MXene constituting the two-dimensional particle of the present embodiment (or a precursor particle to be used for the production of the two-dimensional particle of the present embodiment) will be described.

The single layer or multiple layers can be understood as a layered compound and are also represented by “MₘXₙTₛ”, wherein s is any number and traditionally x or z may be used instead of s. Typically, n can be 1, 2, 3, or 4, but is not limited thereto.

In the above formula of MXene, M is preferably at least one selected from the group consisting of Ti, Zr, Hf, V, Nb, Ta, Cr, Mo, and Mn, and more preferably at least one selected from the group consisting of Ti, V, Cr, and Mo. Most preferably, M includes Ti. M may be only Ti.

Known MXenes include those whose formula MₘXₙ given above is expressed as below.

Sc₂C, Ti₂C, Ti₂N, Zr₂C, Zr₂N, Hf₂C, Hf₂N, V₂C, V₂N, Nb₂C, Ta₂C, Cr₂C, Cr₂N, Mo₂C, Mo_{1.3}C, Cr_{1.3}C, (Ti,V)₂C, (Ti,Nb)₂C, W₂C, W_{1.3}C, Mo₂N, Nb_{1.3}C, Mo_{1.3}Y_{0.6}C (wherein “1.3” and “0.6” mean about 1.3 (=4/3) and about 0.6 (=2/3), respectively),

Ti₃C₂, Ti₃N₂, Ti₃(CN), Zr₃C₂, (Ti,V)₃C₂, (Ti₂Nb)C₂, (Ti₂Ta)C₂, (Ti₂Mn)C₂, Hf₃C₂, (Hf₂V)C₂, (Hf₂Mn)C₂, (V₂Ti)C₂, (Cr₂Ti)C₂, (Cr₂V)C₂, (Cr₂Nb)C₂, (Cr₂Ta)C₂, (Mo₂Sc)C₂, (Mo₂Ti)C₂, (Mo₂Zr)C₂, (Mo₂Hf)C₂, (Mo₂V)C₂, (Mo₂Nb)C₂, (Mo₂Ta)C₂, (W₂Ti)C₂, (W₂Zr)C₂, (W₂Hf)C₂,

Ti₄N₃, V₄C₃, Nb₄C₃, Ta₄C₃, (Ti,Nb)₄C₃, (Nb,Zr)₄C₃, (Ti₂Nb₂)C₃, (Ti₂Ta₂)C₃, (V₂Ti₂)C₃, (V₂Nb₂)C₃, (V₂Ta₂)C₃, (Nb₂Ta₂)C₃, (Cr₂Ti₂)C₃, (Cr₂V₂)C₃, (Cr₂Nb₂)C₃, (Cr₂Ta₂)C₃, (Mo₂Ti₂)C₃, (Mo₂Zr₂)C₃, (Mo₂Hf₂)C₃, (Mo₂V₂)C₃, (Mo₂Nb₂)C₃, (Mo₂Ta₂)C₃, (W₂Ti₂)C₃, (W₂Zr₂)C₃, (W₂Hf₂)C₃, (Mo_{2.7}V_{1.3})C₃, wherein “2.7” and “1.3” mean about 2.7 (=8/3) and about 1.3 (=4/3), respectively.

Typically, in the above formula, M can be titanium or vanadium and X can be a carbon atom or a nitrogen atom. For example, the MAX phase may be Ti₃AlC₂ and MXene may be Ti₃C₂Tₛ (in other words, the layer body is Ti₃C₂, M is Ti, X is C, n is 2, and m is 3). When the layer body is Ti₃C₂, a two-dimensional particle having a high ligand coverage can be provided. In addition, a two-dimensional particle in which the layer body is Ti₃C₂, and the surface of the layer body is substituted with a heteroatom-containing compound having a saturated hydrocarbon group or an unsaturated hydrocarbon group, preferably substituted with an alkylphosphonic acid is preferable because the dispersion stability thereof in an organic dispersion medium is extremely high.

In the present embodiment, MXene may contain A atoms derived from a MAX phase, which is a precursor phase of MXene, at a relatively small amount, for example, at 10% by mass or less relative to the original amount of A atoms. The remaining amount of A atoms can be preferably 8% by mass or less, and more preferably 6% by mass or less. However, even if the remaining amount of A atoms exceeds 10% by mass, there may be no problem depending on the application and conditions of use of the two-dimensional particle.

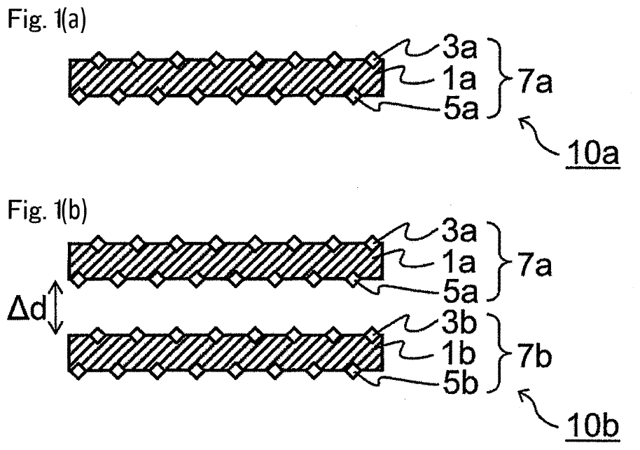

Hereinafter, MXene constituting the two-dimensional particle of the present embodiment (or a precursor particle to be used for the production of the two-dimensional particle of the present embodiment) will be described with reference to FIG. 1. In the following FIGS. 1(a) and 1(b), a substituent derived from a heteroatom-containing compound having a saturated hydrocarbon group or an unsaturated hydrocarbon group on the surface of the layer body is not shown.

The MXene constituting the two-dimensional particle of the present embodiment is an aggregate comprising MXene particles with a single layer (hereinafter simply referred to as “MXene particles”) 10a (single-layer MXene particles) schematically illustrated in FIG. 1(a). More specifically, the MXene particle 10a is a MXene layer 7a having a layer body represented by MₘXₙ (MₘXₙ layer) 1a and modifiers or terminals T3a, 5a existing on a surface of the layer body 1a (more specifically, on at least one of both surfaces facing opposite from each other, of each layer). Therefore, the MXene layer 7a is also represented by “MₘXₙTₛ”, wherein s is any number.

The two-dimensional particle of the present embodiment may comprise a single layer or multiple layers. Examples of the MXene particle with multiple layers (multilayer MXene particle) include, but are not limited to, a MXene particle 10b with two layers as schematically illustrated in FIG. 1(b). 1b, 3b, 5b, and 7b in FIG. 1(b) are the same as 1a, 3a, 5a, and 7a in FIG. 1(a) described above. Two adjacent MXene layers (e.g., 7a and 7b) in the multilayer MXene particle may not necessarily be completely separated from each other, but may be partially in contact with each other. The MXene particle 10a may be one that exists as a single layer resulting from the multilayer MXene particles 10b being separated from one another, and may exist as a mixture of the single-layer MXene particles 10a and the multilayer MXene particles 10b in which some multilayer MXene particles 10b that are not separated remain.

Although not limiting the present embodiment, the thickness of each layer contained in the MXene particle (which corresponds to the MXene layers 7a, 7b) is, for example, not less than 0.8 nm and not more than 5 nm, and particularly not less than 0.8 nm and not more than 3 nm (which can vary mainly depending on the number of M atom layers included in each layer). For individual laminates of the multilayer MXene particle that may be included, the inter-layer distance (or gap dimension, denoted as Δd in FIG. 1(b)) is, for example, not less than 0.8 nm and not more than 10 nm, particularly not less than 0.8 nm and not more than 5 nm, and more particularly about 1 nm, and the total number of layers may be not less than 2 and not more than 20,000.

In the MXene constituting the two-dimensional particle of the present embodiment, the multilayer MXene particle that may be contained is preferably a MXene particle having a small number of layers obtained through delamination treatment. The “small number of layers” means, for example, that the number of laminated layers of MXene is 6 or less. The thickness in the stacking direction of the multilayer MXene particle having a small number of layers is preferably 15 nm or less, and more preferably 10 nm or less. Hereinafter, the “multilayer MXene particle having a small number of layers” may be referred to as “few-layer MXene particle”. The single-layer MXene particle and the few-layer MXene particle may be collectively referred to as “single-layer/few-layer MXene particle”.

The MXene constituting the two-dimensional particle of the present embodiment preferably contains a large amount of single layer/few-layer MXene. It is considered that the specific surface area of MXene can be made larger than that of the multilayer MXene by containing a large amount of the single layer/few-layer MXene, and as a result, the contact area with the ligand increases in the substitution reaction, and the ligand coverage can be increased. For example, in the particle of the layered material according to the present embodiment, the single layer/few-layer MXene, in which the number of laminated layers of MXene is not more than 10 layers and the thickness is 15 nm or less, preferably 10 nm or less, accounts for preferably 80% by volume or more, more preferably 90% by volume or more, and still more preferably 95% by volume or more of the total MXene. More preferably, the volume of the single-layer MXene is larger than the volume of the few-layer MXene. Since the true density of these MXenes does not greatly vary depending on the existence form, it can be said that the mass of the single-layer MXene is more preferably larger than the mass of the few-layer MXene. When these relationships are satisfied, the specific surface area can be further increased, and as a result, for example, dispersion stability can be further improved, and, for example, when the two-dimensional particle of the present embodiment is used for an electrode, deterioration of conductivity over time can be sufficiently suppressed. Most preferably, the MXene constituting the two-dimensional particle of the present embodiment is formed only of the single layer MXene.

In the production process of the two-dimensional particle according to the present embodiment, at least some of hydroxy groups among the modifiers or terminals T existing on the surface of the layer body are substituted with a heteroatom-containing compound having a saturated hydrocarbon group or an unsaturated hydrocarbon group, and the substitution rate (ligand coverage) of the hydroxy groups existing on the surface of the layer body with the heteroatom-containing compound is 37.5% or more.

In the production process of the two-dimensional particle according to the present embodiment, a dehydration condensation reaction occurs between a hydroxy group existing on the surface of the layer body of a MXene particle (precursor particle) and a heteroatom-containing compound having a saturated hydrocarbon group or an unsaturated hydrocarbon group as a ligand. The reaction can also be referred to as a reaction in which (in particular, hydrogen of) a hydroxy group existing on the surface of the layer body of the MXene particle (precursor particle) is substituted with a heteroatom-containing compound (preferably an alkylphosphonic acid) having a saturated hydrocarbon group or an unsaturated hydrocarbon group. Hereinafter, this reaction may be referred to as “ligand substitution”.

The two-dimensional particle according to the present embodiment has a structure in which an M atom (preferably a titanium atom) of the layer body and a heteroatom (preferably one or more atoms selected from the group consisting of phosphorus, nitrogen, sulfur, and silicon, more preferably a phosphorus atom) of a heteroatom-containing compound are covalently bonded or ionically bonded via an oxygen atom by the above reaction (covalent or ionic bond of M-O-heteroatom, preferably covalent or ionic bond of Ti—O-heteroatom, more preferably covalent bond of Ti—O—P). A ligand that exhibits hydrophobicity is connected to MXene via the structure. The covalent bond or ionic bond of the M-O-heteroatom can be confirmed by, for example, EDX or NMR.

In the production process of the two-dimensional particle according to the present embodiment, the substitution reaction of a plurality of hydroxy groups existing on the surface of the layer body of the MXene particle (precursor particle) with that compound proceeds, the covalent bond or ionic bond of the M-O-heteroatom increases, the amount of ligand existing on MXene increases, that is, the ligand coverage increases, so that a large amount of hydrophobic functional groups is introduced to the surface of MXene, and as a result, the hydrophobicity of the surface of MXene increases, and a two-dimensional particle that can be easily dispersed in an organic dispersion medium can be obtained.

Examples of the heteroatom-containing compound include a phosphoric acid compound, a nitrogen-containing compound such as an amine, a silicon-containing compound such as silane, and a sulfur-containing compound. A phosphoric acid compound is preferable. The phosphoric acid compound is preferably a phosphonic acid having a saturated hydrocarbon group or an unsaturated hydrocarbon group. The saturated hydrocarbon group and the unsaturated hydrocarbon group may be an aliphatic hydrocarbon, an alicyclic hydrocarbon, or an aromatic hydrocarbon having 1 or more, or 2 or more, or 3 or more carbon atoms and having, for example, 25 or less, or 20 or less carbon atoms. Some hydrogen of the hydrocarbon may be substituted with a functional group such as —OH, NH₂, —COOH, or —CH═CH—. Examples of the phosphonic acid having a saturated hydrocarbon group or an unsaturated hydrocarbon group include an alkylphosphonic acid. The alkylphosphonic acid is not limited on the alkyl chain length thereof, and examples thereof include alkylphosphonic acids having an alkyl chain of C1 to C15, or C1 to C12. Examples thereof include methylphosphonic acid (C1), propylphosphonic acid (C3), hexylphosphonic acid (C6), octylphosphonic acid (C8), decylphosphonic acid (C10), and dodecylphosphonic acid (C12).

The ligand coverage is 37.5% or more, and preferably 50% or more. As the ligand coverage is increased, the dispersion stability when dispersed in an organic dispersion medium is dramatically improved. As a conceivable mechanism, it is considered to be because the hydrophobic ligand bound to MXene makes the surface hydrophobic, and the degree of hydrophobicity is increased. Furthermore, the two-dimensional particle according to the present embodiment can be dispersed also in an organic dispersion medium compatible with water (solubility in water >10% w/w), in which conventional two-dimensional particles could not be dispersed. As one of the reasons, it is conceivable that the two-dimensional particle according to the present embodiment is present in the form of a single layer or a few layers rather than an aggregate.

The ligand coverage is preferably as high as possible from the viewpoint of enhancing dispersion stability when dispersed in an organic dispersion medium. The upper limit of the ligand coverage can be, for example, preferably about 95%, and more preferably about 90% from the viewpoint of ensuring dispersion stability. The ligand coverage may be calculated as shown in (Calculation of ligand coverage) of Example 1-1 in the section of Examples described later.

The two-dimensional particle can be obtained, for example, by producing it by a recommended production method described later.

### Embodiment 2: Two-Dimensional Particle-Containing Dispersion Liquid

The two-dimensional particle-containing dispersion liquid according to the present embodiment contains the two-dimensional particle and an organic dispersion medium. The two-dimensional particle-containing dispersion liquid according to the present embodiment is excellent in dispersion stability because the ligand coverage of the two-dimensional particle contained therein is high, and a large amount of hydrophobic functional groups are introduced onto the surface of MXene. In addition, according to the two-dimensional particle-containing dispersion liquid according to the present embodiment, due to the use of the organic dispersion medium, the contact with water or oxygen can be reduced to suppress the oxidation of MXene, and the energy consumption for removing the dispersion medium at the time of film formation can be reduced.

The two-dimensional particle contained in the two-dimensional particle-containing dispersion liquid is as described above (Embodiment 1: two-dimensional particle). The organic dispersion medium is not limited. As the organic dispersion medium, an organic dispersion medium compatible with water (solubility in water >10% w/w) may be used, or an organic dispersion medium that does not exhibit compatibility with water may be used. According to the present embodiment, unlike Patent Document 1 and the like, since two-dimensional particles can be dispersed also in an organic dispersion medium compatible with water (solubility in water >10% w/w), the selection of the organic dispersion medium is wider than before. As the organic dispersion medium, for example, one or more selected from the group consisting of ethanol, 2-propanol, ethylene glycol, methanol, acetone, acetonitrile, DMF, NMF, DMSO, and NMP can be used. Examples of the organic dispersion medium that does not exhibit compatibility with water include 1-hexanol, chloroform, and toluene. The organic dispersion medium is preferably one or more selected from the group consisting of ethanol, 2-propanol, and 1-hexanol. The two-dimensional particle-containing dispersion liquid containing such an organic dispersion medium can achieve 50 hours or more in the evaluation of the dispersion stability of a two-dimensional particle (the time taken until the absorbance of ultraviolet-visible absorption spectrum decreases from the initial absorbance to the half thereof) in Examples described later.

### Embodiment 3: Two-Dimensional Particle-Containing Composite

The two-dimensional particle-containing composite according to the present embodiment contains the two-dimensional particle-containing dispersion liquid and a polymeric material. The polymeric material may be a solid such as a particle, for example, a particulate material that can be dispersed together with the two-dimensional particle in the two-dimensional particle-containing dispersion liquid, or may be a water-soluble polymer that can be dissolved in the dispersion liquid, that is, a polymer in a state of being dissolved in the dispersion liquid. When the polymeric material is a solid such as a particle, examples thereof include a particle of one or more among polystyrene, polyurethane, and nylon. Examples of the water-soluble polymer include water-soluble urethane, acrylic polymer, polyethylene glycol, carboxymethyl cellulose (CMC), alginic acid polymer, polyether, polyvinyl alcohol, water-soluble polyester, and dicarboxylated polysaccharide. One or more of these can be used. As the polymeric material, one or more selected from the group consisting of urethane, nylon, and carboxymethyl cellulose (CMC) are preferably contained. When the polymeric material is contained, the proportion of the polymeric material in the two-dimensional particle-containing composite is set to, for example, not less than 0.01% by mass and not more than 50% by mass.

The two-dimensional particle-containing dispersion liquid contained in the two-dimensional particle-containing composite and the two-dimensional particle contained in the dispersion liquid are as described above in (Embodiment 1: two-dimensional particle) and (Embodiment 2: two-dimensional particle-containing dispersion liquid).

The two-dimensional particle-containing composite according to the present embodiment is preferably composed of the two-dimensional particle-containing dispersion liquid and a polymeric material, and may be, for example, a two-dimensional particle-containing dispersion liquid in which a particle composed of the polymeric material is dispersed together with the two-dimensional particle according to the present embodiment.

Since the MXene particles of Patent Document 1 and Non-patent Document 1 can be dispersed only in an organic dispersion medium (solubility in water <10% w/w) that does not mix with water, there has been a problem that there is a limitation on applicable resins when a composite of MXene particles and a resin is prepared. In contrast to this, since the two-dimensional particle contained in the two-dimensional particle-containing composite of the present embodiment can be dispersed in various organic dispersion media, the range of types of usable resins is widened, and composites of the two-dimensional particle of the present embodiment with various resins can be produced.

### Embodiment 4: Two-Dimensional Particle-Containing Film

The two-dimensional particle-containing film according to the present embodiment contains, among the two-dimensional particles described in (Embodiment 1: two-dimensional particle) above, two-dimensional particles having a substitution rate (ligand coverage) of hydroxy groups existing on the surface of the layer body of 75.4% or more. A two-dimensional particle-containing film containing a two-dimensional particle having a high ligand coverage, preferably a two-dimensional particle-containing film substantially composed of the two-dimensional particle having a high ligand coverage (inevitable impurities such as a remaining dispersion medium are acceptable) exhibits high conductivity as shown in Examples described later.

The ligand coverage of the two-dimensional particle contained in the two-dimensional particle-containing film can be more than 75.4%, further 78% or more, further 80% or more, and further 83% or more. Since the MXene particles of Patent Document 1 and Non-patent Document 1 have low dispersion stability in an organic dispersion medium, there is a problem that filtration membranes and spray films produced using the MXene particles have low film quality and cannot exhibit excellent conductivity, which is one of the characteristics of MXene. In contrast to this, the two-dimensional particle-containing film according to the present embodiment has a high ligand coverage of the two-dimensional particle contained in the film and the dispersion stability of the two-dimensional particle in an organic dispersion medium is further improved, and as a result, the film quality of a two-dimensional particle-containing film such as a filtration membrane or a spray film obtained using a two-dimensional particle-containing dispersion liquid is further improved. As a result, the conductivity is dramatically increased. For example, the two-dimensional particle-containing film can achieve a conductivity of preferably not less than 10 S/cm and not more than 20,000 S/cm as measured by the method described in Examples described later. The two-dimensional particle-containing film according to the present embodiment has high conductivity as described above, and is suitably used for, for example, an electrode.

Next, a method for producing the two-dimensional particle-containing film will be described. For example, by applying a two-dimensional particle having a ligand coverage of 75.4% or more to a substrate, a film containing the two-dimensional particle can be formed on the surface of the substrate. In a method of applying the two-dimensional particle to the substrate, for example, the above-described two-dimensional particle-containing dispersion liquid can be used. The two-dimensional particle-containing dispersion liquid may be a suspension. The method for forming the two-dimensional particle-containing film using the two-dimensional particle-containing dispersion liquid is not particularly limited. The two-dimensional particle-containing dispersion liquid may be applied to a substrate as received or after being appropriately conditioned (for example, dilution with a medium liquid, or addition of a binder). Examples of the application method include a method of performing spray application using a nozzle such as a one-fluid nozzle, a two-fluid nozzle, or an air brush, a method such as slit coating using a table coater, a comma coater, or a bar coater, screen printing, or metal mask printing, spin coating, dip coating, and dropping. Examples of the dispersion medium constituting the dispersion liquid include an organic dispersion medium. The organic dispersion medium is not limited. According to the present embodiment, as the organic dispersion medium, the organic dispersion medium compatible with water (solubility in water >10% w/w) described above (Embodiment 2: two-dimensional particle-containing dispersion liquid) may be used, or alternatively, an organic dispersion medium that does not exhibit compatibility with water may be used.

When a two-dimensional particle-containing film is obtained by spraying, first, a slurry containing a two-dimensional particle in an organic dispersion medium is prepared. A two-dimensional particle-containing film can be produced by conducting spray using the slurry prepared in this manner. In the two-dimensional particle-containing film, a liquid component derived from the organic dispersion medium of the slurry may remain, or substantially no such liquid component may exist. The two-dimensional particle-containing film may not contain a so-called binder.

The substrate is not particularly limited, and the substrate may be formed of any appropriate material. The substrate may be, for example, a resin film, a metal foil, a printed wiring board, a mounted electronic component, a metal pin, a metal wiring, or a metal wire. For example, a substrate formed of a metal material, a resin, or the like suitable for an electrode can be appropriately adopted. By applying the slurry to any appropriate substrate (this substrate may be one that is to constitute a prescribed member together with a two-dimensional particle-containing film, or may be finally separated from the two-dimensional particle-containing film), a two-dimensional particle-containing film can be formed on the substrate.

By performing suction filtration instead of the application, a two-dimensional particle-containing film can be formed without including a binder. In addition, a two-dimensional particle-containing film can be formed without using a substrate. In the case of suction filtration, in the two-dimensional particle-containing film, a liquid component derived from the liquid medium of the slurry may remain, or substantially no such liquid component may exist.

Drying may be performed under mild conditions such as natural drying (typically, the item to be dried is placed in an air atmosphere at normal temperature and normal pressure) or air drying (blowing air), or may be performed under relatively active conditions such as hot air drying (blowing heated air), heat drying, and/or vacuum drying. In the present embodiment, “drying” means removing the organic dispersion medium that may exist in the film. The drying may be performed, for example, at a temperature of 400° C. or lower using a normal pressure oven or a vacuum oven.

The formation and drying of the two-dimensional particle-containing film may be appropriately repeated until a desired thickness of the two-dimensional particle-containing film is obtained. For example, a combination of spraying and drying may be repeated a plurality of times.

### Embodiment 5: Method for Producing Two-Dimensional Particle

Hereinafter, a method for producing a two-dimensional particle according to one embodiment of the present disclosure will be described in detail, but the present disclosure is not limited to such an embodiment.

The method for producing a two-dimensional particle according to the present embodiment includes:
(a) preparing a precursor particle comprising a single layer or multiple layers, wherein the layer or layers each includes:
a layer body represented by the following formula:

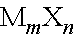

wherein M is one or more metal of Group 3, 4, 5, 6, or 7,
X is a carbon atom, a nitrogen atom, or a combination thereof,
n is not less than 1 and not more than 4, and
m is more than n but not more than 5; and
a modifier or terminal T existing on a surface of the layer body, wherein the T is one or more selected from the group consisting of a hydroxy group, a fluorine atom, a chlorine atom, an oxygen atom, and a hydrogen atom, and comprises at least a hydroxy group;
(b) preparing an aqueous dispersion liquid comprising the precursor particle, and a compound-containing organic solution wherein a heteroatom-containing compound having a saturated hydrocarbon group or an unsaturated hydrocarbon group is dissolved in an organic solvent compatible with the aqueous dispersion liquid; and
(c) mixing and stirring the aqueous dispersion liquid comprising the precursor particle and the compound-containing organic solution to obtain a structure in which an M atom of the layer body and a heteroatom of a heteroatom-containing compound having a saturated hydrocarbon group or an unsaturated hydrocarbon group are covalently bonded or ionically bonded together via an oxygen atom derived from a hydroxy group of the layer body. According to this method, aggregation of the precursor particles (MXene particles) is suppressed, and a two-dimensional particle having a high ligand coverage can be obtained.

In the following, each of the steps of the production method described above will be described in detail.

### Step (a)

A prescribed MXene particle (precursor particle) is prepared. The production of the MXene particle is not limited, and the MXene particle can be produced by, for example, the following method.

### [Etching of MAX Phase]

A particle of a prescribed layered material (MXene particle, precursor particle) can be synthesized by selectively etching (removing and optionally layer-separating) A atoms (and optionally part of M atoms) from a MAX phase. The MAX phase is represented by the formula below:

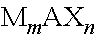

wherein M, X, n, and m are as described above, A is one or more element of Group 12, 13, 14, 15, or 16, normally an element of Group A, typically of Group IIIA and Group IVA, more specifically can comprise at least one selected from the group consisting of Al, Ga, In, Ti, Si, Ge, Sn, Pb, P, As, S, and Cd, and is preferably Al;
and has a crystal structure in which a layer composed of A atoms is located between the two layers represented by MₘXₙ (may have a crystal lattice in which each X is located in the octahedral array of M). When typically m=n+1, but not limited thereto, the MAX phase includes repeating units in which each one layer of X atoms is disposed in between adjacent layers of n+1 layers of M atoms (these are also collectively referred to as an “MₘXₙ layer”), and a layer of A atoms (“A atom layer”) is disposed as a layer next to the (n+1)th layer of M atoms.

Etching for removing at least a part of the A atoms from the precursor is performed using an etching liquid. The etching liquid preferably includes one or more among HF, H₃PO₄, HCl, HI, and H₂SO₄. The etching liquid more preferably includes at least one of HF (hydrofluoric acid) and H₃PO₄ (phosphoric acid). For example, it is also possible to perform etching by a so-called MILD method in which HCl and LiF included in an etching liquid are reacted in a system to generate HF, but it is preferable to perform etching by a so-called ACID method in which etching is performed with an etching liquid including HF (hydrofluoric acid) or etching with an etching liquid including phosphoric acid. These methods are preferable because a particle (MXene particle) of a flaky layered material having a large flat region can thereby be obtained more easily than by the MILD method. Other conditions for etching are not particularly limited, and known conditions can be adopted. As the etching liquid, a mixed solution of the acid and, for example, pure water as a solvent may be used. As the etching liquid, an etching liquid satisfying one or more selected from the group consisting of an HF concentration of not less than 1.5 M and not more than 14 M, an H₃PO₄ concentration of 5.5 M or more, an HCl concentration of 6.0 M or more, an HI concentration of 5.0 M or more, and an H₂SO₄ concentration of 5.0 M or more can be used. In the etching of the A atoms, a part of the M atoms may be selectively etched together with the A atoms. Examples of the etched product obtained by the etching include slurry.

The MAX phase can be produced by a known method. For example, a TiC powder, a Ti powder, and an Al powder are mixed in a ball mill, and the resulting mixed powder is calcined under an Ar atmosphere to afford a calcined body (block-shaped MAX phase). Thereafter, the calcined body obtained is pulverized with an end mill to afford a powdered MAX phase for the next step.

When the A atoms (and, in some cases, a part of the M atoms) are selectively etched (removed, and in some cases, layer-separated) from the MAX phase, the A atom layer (and, in some cases, a part of the M atoms) are removed. The thus exposed surface of the MₘXₙ layer is modified by one or more selected from the group consisting of a hydroxy group, a fluorine atom, a chlorine atom, an oxygen atom, and a hydrogen atom, and the like (including at least a hydroxy group) existing in an etching liquid (usually, an aqueous solution of a fluorine-containing acid is used, the etching liquid is not limited thereto), so that the surface is terminated.

The etching liquid may contain a metal compound containing a monovalent metal ion, and an intercalation treatment of the monovalent metal ion may be performed simultaneously with the etching. Examples of the metal compound containing a monovalent metal ion include those to be used in the intercalation treatment described below. The content of the metal compound containing a monovalent metal ion in the etching liquid is preferably set to 0.001% by mass or more. The content is more preferably 0.01% by mass or more, and still more preferably 0.1% by mass or more. On the other hand, from the viewpoint of dispersibility in a solution, the content of the metal compound containing a monovalent metal ion in the etching liquid is preferably set to 10% by mass or less, and more preferably is 1% by mass or less.

### (Water Washing)

The etched product obtained by the etching is washed with water. By performing water washing, the acid and the like used in the etching can be sufficiently removed. The amount of water to be mixed with the etched product and the washing method are not particularly limited. For example, addition of water, followed by stirring, centrifugation, or the like may be performed. Examples of the stirring method include handshaking and stirring using an automatic shaker, a shear mixer, a pot mill, or the like. The degree of stirring such as the stirring speed and the stirring time may be adjusted according to the amount, concentration, and the like of a material to be treated. The washing with water may be performed once or more. Preferably, washing with water is performed a plurality of times. Specifically, for example, steps (i) to (iv), namely, (i) adding water (to the etched product or the remaining precipitate obtained in the following (iv)), (ii) stirring, (iii) centrifuging the stirred product, and (iv) discarding the supernatant liquid after the centrifugation and collecting the remaining precipitate are performed within a range of not less than twice and, for example, not more than 15 times.

### [Layer Separation of MXene]

Using the treated product obtained by the water washing (water-washed product), the layer separation of MXene (delamination, that is, separating multilayer MXene into single-layer MXene) may be appropriately promoted by any suitable post-treatment (e.g., ultrasonic treatment, handshaking, treatment using an automatic shaker, or the like). Since the shear force of an ultrasonic treatment is so large that the MXene can be destroyed, it is preferable to apply an appropriate shear force by handshaking, an automatic shaker or the like when it is desired to obtain a two-dimensional MXene particle (preferably single-layer MXene) having a larger aspect ratio. Hereinafter, the intercalation treatment and the delamination will be described.

### (Intercalation Treatment)

For example, an intercalation treatment of monovalent metal ions including a step of mixing the etched product obtained by the etching treatment with a metal compound containing a monovalent metal ion may be performed. Examples of the monovalent metal ion constituting the metal compound containing a monovalent metal ion include alkali metal ions such as a lithium ion, a sodium ion, and a potassium ion, a copper ion, a silver ion, and a gold ion. Examples of the metal compound containing a monovalent metal ion include ionic compounds in which the metal ion is bonded to a cation. Examples thereof include an iodide, a phosphate, a sulfide salt including a sulfate, a nitrate, an acetate, and a carboxylate of the metal ion. A lithium ion is preferable as the monovalent metal ion as described above, and metal compounds containing a lithium ion are preferable as the metal compounds containing a monovalent metal ion, ionic compounds of a lithium ion are more preferable, and one or more among an iodide, a phosphate, and a sulfide salt of a lithium ion are still more preferable. The use of a lithium ion as a metal ion is considered to assist the formation of a monolayer due to the fact that water hydrated to the lithium ion has the most negative dielectric constant.

The content of the metal compound containing a monovalent metal ion accounting for in the formulation for the intercalation treatment of a monovalent metal ion is preferably set to 0.001% by mass or more. The content is more preferably 0.01% by mass or more, and still more preferably 0.1% by mass or more. On the other hand, from the viewpoint of dispersibility in the solution, the content of the metal compound containing a monovalent metal ion is preferably set to 10% by mass or less, and more preferably is 1% by mass or less.

A specific method of the intercalation is not particularly limited, and for example, the metal compound containing a monovalent metal ion may be mixed with a water medium clay of the MXene, followed by stirring or leaving to stand. For example, stirring at room temperature may be performed. Examples of the stirring method include a method using a stirring bar of a stirrer or the like, a method using a stirring blade, a method using a mixer, and a method using a centrifugal device. The stirring time may be set according to the production scale of the two-dimensional particle, and may be set, for example, between 12 and 24 hours.

### (Delamination)

Delamination may be performed using an intercalated product obtained by intercalation. For example, delamination includes a step of centrifuging the intercalated product, discarding the supernatant, and then washing the remaining precipitate with water. Conditions for the delamination treatment are not particularly limited. The dispersion medium to be used for the delamination is not particularly limited, and the delamination may be performed using one or more of a polar organic dispersion medium and an aqueous dispersion medium. For example, a process of adding one or more of the polar organic dispersion medium and the aqueous dispersion medium, stirring the mixture, centrifuging the mixture, and collecting the supernatant liquid is repeated once or more, preferably twice or more and 10 times or less, whereby a supernatant liquid containing a single-layer/few-layer MXene is obtained as a delaminated product. Alternatively, by centrifuging the supernatant liquid, followed by discarding the supernatant liquid resulting from the centrifugation, a clay containing a single-layer/few-layer MXene may be obtained as a delaminated product. The obtained delaminated product may be used as an aqueous dispersion liquid containing a precursor particle.

A dried product of the precursor particle may be obtained by, for example, removing the dispersion medium contained in the supernatant liquid containing a single-layer/few-layer MXene or the clay containing the single-layer/few-layer MXene, which is a delaminated product.

### Step (b)

An aqueous dispersion liquid comprising the precursor particle, and a compound-containing organic solution wherein a heteroatom-containing compound having a saturated hydrocarbon group or an unsaturated hydrocarbon group is dissolved in an organic solvent compatible with the aqueous dispersion liquid are prepared.

As the aqueous dispersion liquid containing the precursor particle, the clay containing the single-layer/few-layer MXene obtained by the delamination may be used as received, or alternatively, the aqueous dispersion liquid with the water content thereof adjusted may be adjusted. Alternatively, a dispersion prepared by dispersing the precursor particle (dried product) obtained by the above method in water may also be used. The proportion of the precursor particle contained in the aqueous dispersion liquid containing the precursor particle may be, for example, in the range of 0.01% by mass to 1% by mass (solid content).

Unlike Patent Document 1 and the like, the aqueous dispersion liquid containing the precursor particle is not acidic but neutral when mixed with the compound-containing organic solution. The aqueous dispersion liquid containing the precursor particle preferably has a pH in the range of 6 to 8. That is, there is a difference from Patent Document 1 and Non-patent Document 1 in that an acid such as hydrochloric acid is not added to the aqueous dispersion liquid containing the precursor particle (MXene particle) before mixing with the compound-containing organic solution.

A compound-containing organic solution in which a heteroatom-containing compound having a saturated hydrocarbon group or an unsaturated hydrocarbon group is dissolved in an organic solvent compatible with the aqueous dispersion liquid is prepared. As the heteroatom-containing compound having a saturated hydrocarbon group or an unsaturated hydrocarbon group, the compound described above can be used. The organic solvent to be used for the preparation of the compound-containing organic solution is not particularly limited as long as it is compatible with the aqueous dispersion liquid (solubility in water >10% w/w). As the organic solvent compatible with water (solubility in water >10% w/w), for example, one or more selected from the group consisting of ethanol, 2-propanol, ethylene glycol, methanol, acetone, acetonitrile, DMF, NMF, DMSO, and NMP can be used.

The proportion of the heteroatom-containing compound having a saturated hydrocarbon group or an unsaturated hydrocarbon group contained in the compound-containing organic solution may be, for example, in the range of 0.01 mol/L to 1 mol/L.

### Step (c)

The aqueous dispersion liquid comprising the precursor particle and the compound-containing organic solution are mixed and stirred to afford a structure in which an M atom of the layer body and a heteroatom of a heteroatom-containing compound having a saturated hydrocarbon group or an unsaturated hydrocarbon group are covalently bonded or ionically bonded together via an oxygen atom derived from a hydroxy group of the layer body.

The method for mixing and stirring the aqueous dispersion liquid containing the precursor particle and the compound-containing organic solution is not particularly limited. The stirring can be conducted, for example, in the range of not less than 6 hours and not more than 24 hours. According to the present embodiment, since an aqueous dispersion liquid containing a precursor particle and a compound dissolved in an organic solvent compatible with the aqueous dispersion liquid are mixed and stirred, the reaction mode is a reaction mode in which a precursor particle (MXene particle) and a ligand are contained in the same system rather than a phase separation type interface reaction as in Patent Document 1 or the like. Therefore, the contact frequency between hydroxy groups on MXene and ligands is higher than that in the phase separation type interface reaction, and the substitution reaction can be promoted without adding hydrochloric acid as in Patent Document 1 or the like. As a result, the substitution rate (ligand coverage) with a ligand on the surface of a precursor particle (MXene particle) can be improved.

The blending ratio of the heteroatom-containing compound to the precursor particle is preferably as large as possible, and precursor particle:heteroatom-containing compound=1:(3 or more). For example, when the precursor particle is Ti₃C₂(OH)₂ and the heteroatom-containing compound is dodecylphosphonic acid, the blending ratio may be precursor particle:heteroatom-containing compound (molar ratio)=1:(3 to 20), and further precursor particle:heteroatom-containing compound (molar ratio)=1:(6 to 10).

The method for producing a two-dimensional particle according to the present embodiment merely needs to include at least the steps (a) to (c) in this order, and other steps are not limited. For example, after the step (c), a step of washing the ligand-substituted MXene particle obtained in the reaction may be included.

### EXAMPLES

In the following, the present disclosure will be described more specifically with reference to Examples. The present disclosure is not limited by the following Examples, and can be implemented with appropriate modifications as long as the modifications can be consistent with the above-described and later-described gist, and all of them are included in the technical scope of the present disclosure.

### Example 1-1

In this example, dodecylphosphonic acid (phosphonic acid having an alkyl chain length of 12 (C12)) was used as a ligand (heteroatom-containing compound, surface modifier), and an alkylphosphonic acid-substituted MXene particle was prepared as a two-dimensional particle (ligand-substituted MXene particle). However, the type of the alkylphosphonic acid is not limited, and various alkylphosphonic acids can be used. When a raw material such as the alkylphosphonic acid is changed, the added weight and the like may change in consideration of each molecular weight.

### (Preparation of MXene Particle (Precursor Particle))

First, [1] preparation of precursor (MAX), [2] etching of precursor, [3] washing after etching, [4] Li intercalation, and [5] delamination, each described in detail below, were sequentially conducted to afford a precursor particle (single-layer/few-layer MXene-containing sample, MXene particle) to be subjected to treatment such as ligand substitution.

### [1] Preparation of Precursor (MAX)

TiC powder, Ti powder, and Al powder (all manufactured by Kojundo Chemical Laboratory Co., Ltd.) were placed in a ball mill containing zirconia balls at a molar ratio of 2:1:1 and mixed for 24 hours. The obtained mixed powder was calcined in an Ar atmosphere at 1350° C. for 2 hours. The calcined body (block-shaped MAX) thus obtained was pulverized with an end mill to a maximum size of 40 m or less. Thereby, a Ti₃AlC₂ particle was obtained as a precursor (powdered MAX).

### [2] Etching of Precursor (MAX)

Using the Ti₃AlC₂ particle (powder) prepared by the above method, etching was performed under the following etching conditions, affording a solid-liquid mixture (slurry) containing a solid component derived from the Ti₃AlC₂ powder.

### (Etching Conditions)

Precursor: Ti₃AlC₂ (sieved with a mesh size of 45 m)
Etching liquid composition: 6 mL of 49% HF
H₂O 18 mL
HCl (12 M) 36 mL
Amount of precursor input: 3.0 g
Etching container: 100 mL AIBOY
Etching temperature: 35° C.
Etching time: 24 h
Stirrer rotation speed: 400 rpm
   [3] Washing after Etching

The slurry was divided into two portions and inserted into two 50 mL centrifuge tubes. Thereafter, the slurry was centrifuged at 3500 G for 5 minutes using a centrifuge, and then the supernatant liquid was discarded. Thereafter, (i) 40 mL of pure water was added to the remaining precipitate in each centrifuge tube, (ii) centrifugation was performed again under the conditions of 3500 G and 5 minutes, and (iii) the supernatant liquid was removed. The operations (i) to (iii) were repeated 11 times. After final centrifugation, the supernatant liquid was discarded, affording a Ti₃AlC₂Tₓ-water medium clay.

### [4] Li Intercalation

The Ti₃AlC₂Tₓ-water medium clay prepared by the above method was stirred at not lower than 20° C. and not higher than 25° C. for 12 hours using LiCl as a Li-containing compound in accordance with the following conditions, whereby Li intercalation was performed.

### (Conditions of Li Intercalation)

Ti₃AlC₂Tₓ-water medium clay (MXene after washing): solid content: 0.75 g
LiCl: 0.75 g
Intercalation container: 100 mL AIBOY
Temperature: not lower than 20° C. and not higher than 25° C. (room temperature)
Time: 12 hours
Stirrer rotation speed: 800 rpm

### [5] Delamination

The slurry obtained by Li intercalation was charged into a 50 mL centrifuge tube, centrifuged under the condition of 3500 G using a centrifuge, and then the supernatant liquid was discarded. Next, (i) 40 mL of pure water was added to the remaining precipitate, and the mixture was stirred for 15 minutes with a shaker, then (ii) centrifuged at 3500 G, and (iii) the supernatant liquid was collected as a single-layer/few-layer MXene-containing liquid. The operations (i) to (iii) were repeated 4 times in total, affording a single-layer/few-layer MXene-containing supernatant liquid. Further, this supernatant liquid was centrifuged under the conditions of 4300 G and 2 hours using a centrifuge, and then the supernatant liquid was discarded, whereby a single-layer/few-layer MXene-containing clay (hereinafter simply referred to as MXene clay) as a remaining precipitate was obtained as a clay containing a MXene particle (precursor particle).

In this example, using the clay (MXene clay) containing the MXene particle (precursor particle) obtained in the preparation of the MXene particle (precursor particle), (1) synthesis of ligand-substituted MXene particle, (2) washing of ligand-substituted MXene particle, and (3) preparation of ligand-substituted MXene particle-containing dispersion liquid, which will be described in detail below, were sequentially conducted, affording a ligand-substituted MXene particle-containing dispersion liquid. Then, using the ligand-substituted MXene particle-containing dispersion liquid, (4) ligand coverage evaluation by TG-DTA and (5) evaluation of dispersion stability were conducted.

### (1) Synthesis of Ligand-Substituted MXene Particle

The MXene clay was dispersed in pure water to prepare a MXene particle-containing aqueous dispersion liquid prepared to have a MXene solid concentration of 1 mg/mL. 20 mL of the MXene particle-containing aqueous dispersion liquid was prepared and transferred to a 50 mL vial containing a stirring bar. In another vial was weighed 165.2 mg (0.660 mmol) of dodecylphosphonic acid (manufactured by Tokyo Chemical Industry Co., Ltd.), and the dodecylphosphonic acid was completely dissolved in 5 mL of ethanol (manufactured by FUJIFILM Wako Pure Chemical Corporation). The organic solvent used for dissolving dodecylphosphonic acid is not limited to ethanol as long as it is compatible with water.

To the vial containing the MXene particle-containing dispersion liquid was added 5 mL of dodecylphosphonic acid dissolved in ethanol, and the mixture was stirred at a stirring speed of 800 rpm for 24 hours at room temperature of 20 to 25° C. using a magnetic stirrer, affording a mixed solution. It was found that the mixed solution was not phase-separated during stirring or even when stirring was stopped, and had a homogeneous mode. The pH of the mixed solution was measured and found to be 6.1. It is considered that by the production using the method according to the present embodiment, a substitution reaction can be conducted in a state in which the MXene particle and dodecylphosphonic acid are contained in the same system, and as a result, the efficiency of the substitution reaction is improved and the ligand coverage to MXene is improved.

### (2) Washing of Ligand-Substituted MXene Particle

The stirred sample liquid was transferred to a 50 mL centrifuge tube, centrifuged under conditions of room temperature, 5000 rpm, and 5 minutes, and then the supernatant liquid was discarded. Then, 20 mL of ethanol was added to the precipitate, which was then redispersed. The operation of adding ethanol to the precipitate, centrifuging the mixture, and discarding the supernatant liquid was further repeated twice (three times in total), whereby unreacted dodecylphosphonic acid, and MXene in which no substitution reaction occurred were removed.

### (3) Preparation of Ligand-Substituted MXene Particle-Containing Dispersion Liquid

After discarding the supernatant liquid generated by the third centrifugation in the above (2), 20 mL of ethanol as an organic dispersion medium was added to the precipitate, which was then dispersed to prepare a dispersion liquid in which a ligand-substituted MXene particle was dispersed in the organic dispersion medium. The organic dispersion medium for dispersing the ligand-substituted MXene particle is not limited, and any organic dispersion medium other than the above can be used.

### (4) Evaluation of Ligand Coverage

The ligand-substituted MXene particle-containing dispersion liquid after the centrifugation in the above (2) was transferred to a 10 mL petri dish, and ethanol as a dispersion medium was removed by natural drying, affording a ligand-substituted MXene particle. As long as a ligand-substituted MXene particle is obtained, the method for removing the dispersion medium is not limited to the above method, and the dispersion medium can be removed by suction filtration or the like.

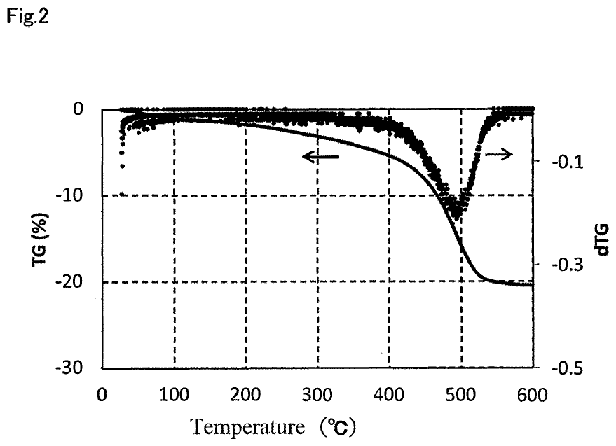

The thermal decomposition behavior of the obtained ligand-substituted MXene particle was confirmed using TG-DTA (manufactured by Bruker: 2000SA) under conditions of room temperature to 600° C., a N₂ atmosphere, and a heating rate of 10° C./min. Consequently, the results of weight loss are shown in FIG. 2. From FIG. 2, ligand-derived weight loss was confirmed around 500° C., and the weight loss rate at 600° C. was 19.33%.

### (Calculation of Amount of Ligand Substitution)

The calculation of the amount of ligand substitution will be described. Since the ligand-substituted MXene particle contained water and a residual organic dispersion medium (ethanol) though slightly, weight loss was confirmed even up to around 100° C. However, since the weight loss up to around 100° C. is irrelevant to the weight loss due to ligand substitution, the absolute value of the value obtained by subtracting the absolute value of the weight loss rate at 100° C. from the absolute value of the weight loss rate at 600° C. was taken as the weight loss rate due to ligand substitution. In this example, 19.33% obtained by subtracting the absolute value (1.10%) of the weight loss rate at 100° C. from the absolute value (20.43%) of the weight loss rate at 600° C. was taken as the weight loss rate due to ligand substitution (also referred to as “amount of ligand substitution”).

### (Calculation of Ligand Coverage)

Next, calculation of the ligand coverage will be described. The amount of ligand substitution calculated in the above (calculation of amount of ligand substitution) is merely a number that can be used only when dodecylphosphonic acid is used as a ligand. Assuming a case where a ligand other than dodecylphosphonic acid is also used, the ligand coverage is determined in a generalized concept of ligands.

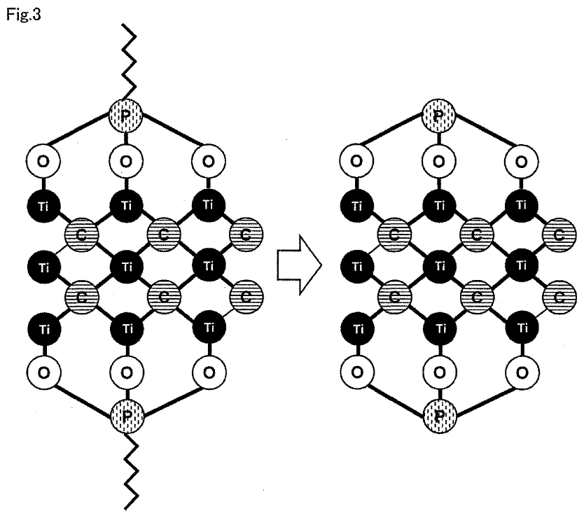

In considering the ligand coverage, first, the following [a] to [c] were assumed.

[a] Three Ti—OHs are substituted with one ligand to form a “(Ti—O)₃-ligand” as illustrated particularly on the left schematic diagram of FIG. 3.

[b] Substituents on MXene are all Ti—OH, and all —OHs in all the Ti—OHs are substituted with a ligand.

[c] In TG-DTA, only the alkyl chain moiety of the ligand is thermally decomposed and weight loss occurs as illustrated in FIG. 3.

The unit cell molecular weight was calculated before and after the thermal decomposition, and the weight loss rate based on the above assumptions [a] to [c] was estimated to be 33.62%.

In fact, the substituents on MXene include not only —OH but also —Cl and —F. Therefore, the proportion of substituents other than —OH was considered as follows. Combustion IC (Ion Chromatography) analysis of MXene was conducted, and the weight proportions of F and Cl in MXene were first measured. Then, from these measured values, the proportions of —OH, —F, and —Cl in the substituent on MXene were estimated. As a result of the estimation, the ratio of substituents of MXene was OH:Cl:F=65:5:30. The weight loss rate of 33.62% assuming that the substituents on MXene are only —OHs is multiplied by the proportion 0.65 of the —OHs occupying among the substituents on MXene. Thereby, the weight loss rate (theoretical value) due to ligand substitution, 21.85%, was calculated. This numerical value is one attained when all —OHs among the substituents on MXene are substituted with ligands.

The ligand coverage was determined from [weight loss rate due to ligand substitution (measured value)/weight loss rate due to ligand substitution (theoretical value)]×100(%) using the weight loss rate due to ligand substitution (theoretical value) calculated as described above. In this example, the weight loss rate (measured value) due to ligand substitution was 19.33%, and the weight loss rate (theoretical value) due to ligand substitution was 21.85%. Using these values, the ligand coverage was determined as (19.33%/21.85%)×100=88.5%.

### (5) Evaluation of Dispersion Stability

The dispersion stability was evaluated using the ligand-substituted MXene particle-containing dispersion liquid prepared in the above (3).

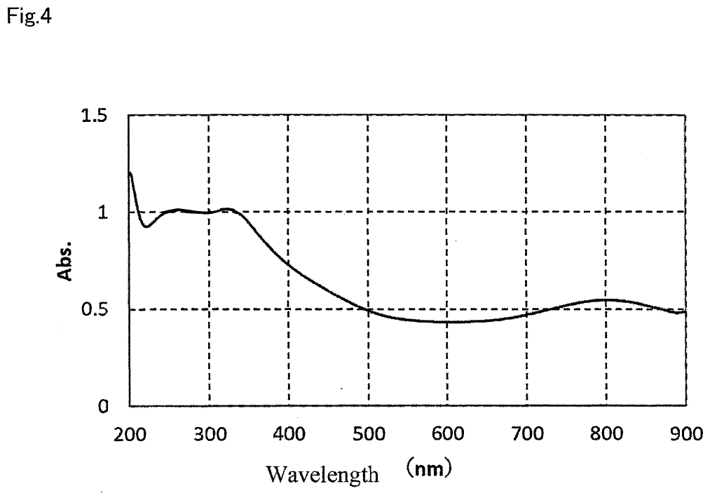

To a 50 mL vial was added 30 mL of the ligand-substituted MXene particle-containing dispersion liquid. At this time, as shown in FIG. 4, an ultraviolet-visible spectrophotometer (UV-1800 manufactured by Shimadzu Corporation) was used and adjusted such that the absorbance at 800 nm, which is specific to MXene, was about 0.5 (this operation was conducted to equalize the approximate concentration of the ligand-substituted MXene particle). Hereinafter, a numerical value at 800 nm is used as the absorbance in the ligand-substituted MXene particle.

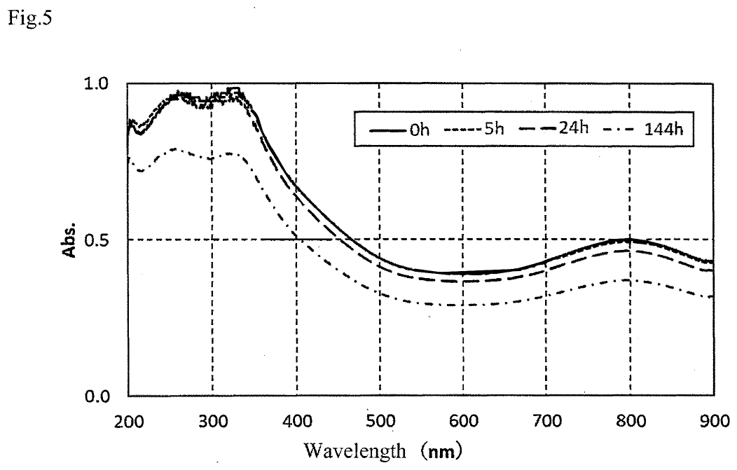

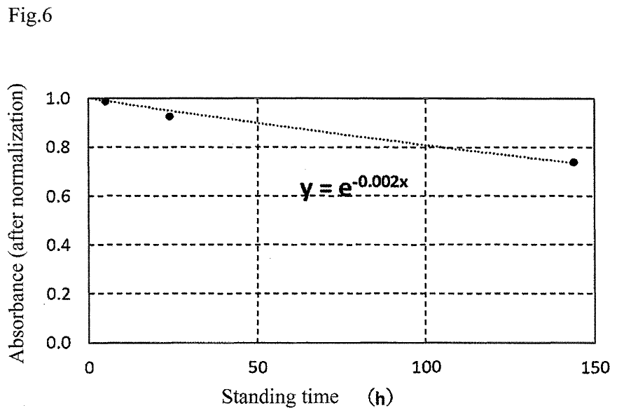

The dispersion liquid was subjected to an ultrasonic treatment for 10 minutes to sufficiently disperse the ligand-substituted MXene particle, and then the dispersion liquid was allowed to stand. Then, the supernatant liquid of the dispersion liquid was extracted, and the absorbance was checked with an ultraviolet-visible spectrophotometer. When the supernatant solution was extracted, the supernatant solution was gently collected so as not to disturb the precipitate. The operation of extracting the supernatant liquid of this dispersion liquid and measuring the absorbance was conducted at regular intervals, and the sedimentation rate (=dispersion stability) of the ligand-substituted MXene particle over time was evaluated. The results are shown in FIGS. 5 and 6. FIG. 5 shows the results of measuring the absorbance at a wavelength of 200 to 900 nm for each of the standing times of 0 hours, 5 hours, 24 hours, and 144 hours. FIG. 6 is a graph showing the ratio of the absorbance at a standing time of 5 hours, 24 hours, or 144 hours to the initial absorbance (the ratio of the absorbance to the initial absorbance; also referred to as “absorbance (after normalization)”), where the absorbance at a standing time of 0 hours (immediately after the ultrasonic treatment) at a wavelength of 800 nm in FIG. 5 (initial absorbance) was 1.0. In this example, dispersion stability was evaluated on the basis of the time taken until the ratio of the absorbance to the initial absorbance reached 0.5. That time was determined by obtaining a relational expression between the measured standing time and the ratio of the absorbance to the initial absorbance (the absorbance (after normalization)) from the above measurement results or by directly reading from the graph. The longer the time is, the better the dispersion stability is. In Example 1-1, a relational expression between the measured standing time and the ratio of the absorbance to the initial absorbance (absorbance (after normalization)) was obtained, and from the relational expression, the time taken until the ratio of the absorbance to the initial absorbance reached 0.5 was calculated, and found to be 347 hours.

### Example 1-2

A ligand-substituted MXene particle was prepared by the same procedure as in Example 1-1 except that the weighing value of dodecylphosphonic acid was changed from 165.2 mg to 99.1 mg or 132.2 mg in (1) of Example 1-1.

### (Evaluation of Ligand Coverage)

The ligand coverage was evaluated in the same manner as in (4) in Example 1-1. The results are shown in Table 1 together with the result of Example 1-1.

From the results in Table 1, it has been found that there is a correlation between the amount of dodecylphosphonic acid during synthesis and the ligand coverage, and the ligand coverage tends to be low when the amount of dodecylphosphonic acid is small.

### (Evaluation of Dispersion Stability)

The dispersion stability of the ligand-substituted MXene particle-containing dispersion liquid was evaluated in the same manner as in (5) of Example 1-1. The results are shown in Table 1 together with the result of Example 1-1.

TABLE 1

| | Amount of dodecylphosphonic acid (mg) | | |
|---|---|---|---|
| | 99.1 | 132.2 | 165.2 |
| Amount of ligand | 8.2 | 9.4 | 19.3 |
| substitution (%) | | | |
| Ligand coverage (%) | 37.5 | 43.2 | 88.5 |
| Dispersion stability (Hour) | 50 | 53 | 347 |

As shown in Table 1, the dispersion stability of the ligand-substituted MXene particle-containing dispersion liquid was higher as the ligand coverage was higher. It was found that all the ligand-substituted MXene particles having a ligand coverage of 37.5% or more had a dispersion stability of 50 hours or more.

### Example 1-3

A ligand-substituted MXene particle was prepared by the same procedure as in Example 1-1 except that the organic dispersion medium to be used in the preparation of the ligand-substituted MXene particle-containing dispersion liquid in (3) of Example 1-1 was changed to 2-propanol or 1-hexanol in place of ethanol.

### (Evaluation of Ligand Coverage)

The ligand coverage was evaluated in the same manner as in (4) in Example 1-1. The results are shown in Table 2 together with the result of Example 1-1.

### (Evaluation of Dispersion Stability)

The dispersion stability of the ligand-substituted MXene particle-containing dispersion liquid was evaluated in the same manner as in (5) of Example 1-1. The results are shown in Table 2 together with the result of Example 1-1.

TABLE 2

| | Type of organic dispersion medium | | | | |
|---|---|---|---|---|---|
| | 2-Propanol | | 1-Hexanol | | Ethanol |
| Ligand coverage (%) | 37.5 | 88.5 | 37.5 | 88.5 | 88.5 |
| Dispersion stability (Hour) | 87 | 347 | 116 | 693 | 347 |

From the results in Table 2, it was confirmed that all the ligand-substituted MXene particles having a ligand coverage of 37.5% or more had a dispersion stability of 50 hours or more.

### Comparative Example 1-1

### (1) Synthesis of Ligand-Substituted MXene Particle

The MXene clay was dispersed in pure water to prepare a MXene particle-containing dispersion liquid prepared to have a MXene solid concentration of 1 mg/mL. 20 mL of the MXene particle-containing dispersion liquid was prepared and transferred to a 50 mL vial containing a stirring bar. Thereafter, 10 μL of hydrochloric acid (manufactured by FUJIFILM Wako Pure Chemical Corporation) was added to the MXene particle-containing dispersion liquid to make the pH of the MXene particle-containing dispersion liquid acidic, that is, adjust the pH from about 7 to 2.5. In another vial was weighed 33.0 mg (0.13 mmol) of dodecylphosphonic acid (manufactured by Tokyo Chemical Industry Co., Ltd.), and the dodecylphosphonic acid was completely dissolved in 20 mL of 1-hexanol (manufactured by FUJIFILM Wako Pure Chemical Corporation).

To the vial containing the MXene particle-containing dispersion liquid was added 20 mL of dodecylphosphonic acid dissolved in 1-hexanol, and the mixture was stirred at a stirring speed of 1500 rpm for 24 hours at room temperature of 20 to 25° C. using a magnetic stirrer, affording a mixed solution. The mixed solution had separated into two phases of an aqueous phase and a 1-hexanol phase unlike the mixed solution obtained in Example 1-1. In addition, MXene had aggregated due to the addition of hydrochloric acid to the MXene particle-containing dispersion liquid.

### (2) Washing of Ligand-Substituted MXene Particle

The 1-hexanol phase in the stirred sample liquid was transferred to a 50 mL centrifuge tube, centrifuged under conditions of room temperature, 8000 rpm, and 8 minutes, and then the supernatant liquid was discarded. Then, 20 mL of ethanol was added to the precipitate, which was then redispersed. The operation of adding ethanol to the precipitate, centrifuging the mixture, and discarding the supernatant liquid was further repeated twice (three times in total), whereby unreacted dodecylphosphonic acid was removed.

### (3) Preparation of Ligand-Substituted MXene Particle-Containing Dispersion Liquid and (4) Evaluation of Ligand Coverage

A ligand-substituted MXene particle-containing dispersion liquid was prepared in the same manner as in (3) of Example 1-1, and then ligand-substituted MXene particles were obtained. Then, the thermal decomposition behavior of the ligand-substituted MXene particle was confirmed in the same manner as (4) of Example 1-1.

### (Calculation of Amount of Ligand Substitution)

The calculation of the amount of ligand substitution will be described. Since the ligand-substituted MXene particle contained water and a residual organic dispersion medium (1-hexanol) though slightly, weight loss was confirmed even at around 100° C. and around 200° C. However, since the weight loss at the above temperatures is irrelevant to the weight loss due to ligand substitution, the value obtained by subtracting the absolute value of the weight loss rate at 200° C. from the absolute value of the weight loss rate at 600° C. was taken as the weight loss rate due to ligand substitution. In this example, 3.12% obtained by subtracting the absolute value (2.62%) of the weight loss rate at 200° C. from the absolute value (5.74%) of the weight loss rate at 600° C. was taken as the weight loss rate by ligand substitution (also referred to as “amount of ligand substitution”). Subsequently, the ligand coverage was calculated in the same manner as in (4) of Example 1-1, and the ligand coverage was found to be 14.2%.

### (5) Evaluation of Dispersion Stability

The dispersion stability of the ligand-substituted MXene particle-containing dispersion liquid was evaluated in the same manner as in (5) of Example 1-1. As a result, the time taken until the ratio of the absorbance to the initial absorbance reached 0.5 was 9 hours.

### Comparative Example 1-2

A ligand-substituted MXene particle was prepared by the same procedure as in Comparative Example 1-1 except that the weighing value of dodecylphosphonic acid was changed from 33.0 mg to 99.1 mg, 132.2 mg or 165.2 mg in (1) of Comparative Example 1-1.

### (Evaluation of Ligand Coverage)

The ligand coverage was evaluated in the same manner as in (4) in Example 1-1. The results are shown in Table 3 together with the result of Comparative Example 1-1.

### (Evaluation of Dispersion Stability)

The dispersion stability of the ligand-substituted MXene particle-containing dispersion liquid was evaluated in the same manner as in (5) of Example 1-1. The results are shown in Table 3 together with the result of Comparative Example 1-1.

TABLE 3

| | Amount of dodecylphosphonic acid (mg) | | | |
|---|---|---|---|---|
| | 33.0 | 99.1 | 132.2 | 165.2 |
| Amount of ligand | 3.1 | 5.6 | 5.5 | 7.0 |
| substitution (%) | | | | |
| Ligand coverage (%) | 14.2 | 25.6 | 25.0 | 32.1 |
| Dispersion stability (Hour) | 9 | 9 | 8 | 12 |

As shown in Table 3, in the methods according to Comparative Examples, even when the amount of dodecylphosphonic acid used for synthesis of a ligand-substituted MXene particle was increased from 33.0 mg to 165.2 mg, the ligand coverage was about 32%, and the ligand coverage could not be increased. It was found that all the ligand-substituted MXene particles having a ligand coverage of less than 37.5% had a dispersion stability of less than 50 hours.

### Comparative Example 1-3

A ligand-substituted MXene particle was prepared by the same procedure as in Comparative Example 1-1 except that the weighing value of dodecylphosphonic acid was 33.0 mg (0.13 mmol) (the same as in Comparative Example 1-1) or 165.2 mg in (1) of Comparative Example 1-1 and the dispersion medium used for preparing the ligand-substituted MXene particle-containing dispersion liquid was changed to 2-propanol or 1-hexanol instead of ethanol in (3) of Comparative Example 1-1.

### (Evaluation of Ligand Coverage)

The thermal decomposition behavior of the ligand-substituted MXene particle was confirmed in the same manner as (4) of Example 1-1. The result is shown in Table 4.

### (Evaluation of Dispersion Stability)

The dispersion stability of the ligand-substituted MXene particle-containing dispersion liquid was evaluated in the same manner as in (5) of Example 1-1. The result is shown in Table 4.

TABLE 4

| | Type of organic dispersion medium | | | |
|---|---|---|---|---|
| | 2-Propanol | | 1-Hexanol | |
| Amount of dodecylphosphonic | 33.0 | 165.2 | 33.0 | 165.2 |
| acid (mg) | | | | |
| Ligand coverage (%) | 14.2 | 32.1 | 14.2 | 32.1 |
| Dispersion stability (Hour) | 22 | 29 | 39 | 43 |

From Table 4, it was found that all the ligand-substituted MXene particles having a ligand coverage of less than 37.5% had a dispersion stability of less than 50 hours.

Comparison between Examples 1-1 to 1-3 and Comparative Examples 1-1 to 1-3 has revealed that due to the fact that hydrochloric acid was not used and not a two-layer separation system but a mixed homogeneous system was employed to increase the contact frequency between the ligand and MXene in the production process of a ligand-substituted MXene particle, the ligand coverage to MXene was dramatically improved from about 14% to about 89%.

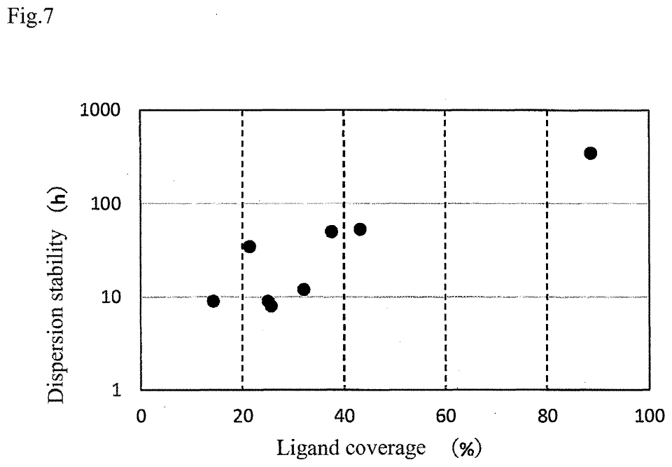

FIG. 7 is a diagram showing the relationship between ligand coverage and dispersion stability using the results of Examples 1-1 to 1-3 and Comparative Examples 1-1 to 1-3. From FIG. 7, as the ligand coverage to MXene was dramatically increased from about 14% to about 89%, the dispersion stability was also dramatically improved from 9 hours to 347 hours. In particular, when the ligand coverage was 37.5% or more, the dispersion stability was 50 hours or more, and high dispersion stability was exhibited.

### Example 2

In Example 2, a film was formed using a dispersion liquid of a ligand-substituted MXene particle, and the conductivity of the obtained ligand-substituted MXene film was evaluated. In detail, in Example 2, using the clay (MXene clay) containing the MXene particle (precursor particle) obtained in the preparation of the MXene particle (precursor particle), (1) synthesis of ligand-substituted MXene particle, (2) washing of ligand-substituted MXene particle, (3) preparation of ligand-substituted MXene particle-containing dispersion liquid, (4) film formation using ligand-substituted MXene particle-containing dispersion liquid, and (5) evaluation of conductivity of ligand-substituted MXene film, which will be described in detail below, were conducted.

### (1) Synthesis of Ligand-Substituted MXene Particle

The MXene clay was dispersed in pure water to prepare a MXene particle-containing dispersion liquid prepared to have a MXene solid concentration of 1 mg/mL. 20 mL of the MXene particle-containing dispersion liquid was prepared and transferred to a 50 mL vial containing a stirring bar. In another vial, 63.4 mg (0.65 mmol) of methylphosphonic acid (manufactured by Tokyo Chemical Industry Co., Ltd.) was weighed, and the methylphosphonic acid was completely dissolved in 5 mL of ethanol (manufactured by FUJIFILM Wako Pure Chemical Corporation). The organic solvent used for dissolving methylphosphonic acid is not limited to ethanol as long as it is compatible with water.

To the vial containing the MXene particle-containing dispersion liquid was added 5 mL of methylphosphonic acid dissolved in ethanol, and the mixture was stirred at a stirring speed of 800 rpm for 24 hours at room temperature of 20 to 25° C. using a magnetic stirrer, affording a mixed solution. It was found that the mixed solution was not phase-separated during stirring or even when stirring was stopped, and had a homogeneous mode. The pH of the mixed solution was measured and found to be 6.5. It is considered that by the production using the method according to the present embodiment, a substitution reaction can be conducted in a state in which MXene and methylphosphonic acid are contained in the same system, and as a result, the efficiency of the substitution reaction is improved and the ligand coverage to MXene is improved.

### (2) Washing of Ligand-Substituted MXene Particle

The stirred sample liquid was transferred to a 50 mL centrifuge tube, centrifuged under conditions of room temperature, 5000 rpm, and 5 minutes, and then the supernatant liquid was discarded. Then, 20 mL of ethanol was added to the precipitate, which was then redispersed. The operation of adding ethanol to the precipitate, centrifuging the mixture, and discarding the supernatant liquid was further repeated twice (three times in total), whereby unreacted methylphosphonic acid was removed.

### (3) Preparation of Ligand-Substituted MXene Particle-Containing Dispersion Liquid

After discarding the supernatant liquid generated by the third centrifugation in the above (2), 20 mL of ethanol as an organic dispersion medium was added to the precipitate, which was then dispersed to prepare a dispersion liquid in which a ligand-substituted MXene particle was dispersed in the organic dispersion medium. The organic dispersion medium for dispersing the ligand-substituted MXene particle is not limited, and any organic dispersion medium other than the above can be used.

### (4) Film Formation Using Ligand-Substituted MXene Particle-Containing Dispersion Liquid

80 mL of the ligand-substituted MXene particle-containing dispersion liquid prepared in the above (3) was prepared. The ligand-substituted MXene particle-containing dispersion liquid was applied to a glass substrate as follows using a spray coater (M1822J, manufactured by Muramatsu Co., Ltd.). First, a 3 cm square glass substrate (TEMPAX, manufactured by SCHOTT) was cleaned with oxygen plasma for 1 minute and set on a stage of the spray coater. Subsequently, the ligand-substituted MXene particle-containing dispersion liquid was applied to the glass substrate under the following spray coating conditions to form a film. The obtained spray film (ligand-substituted MXene film) was dried under conditions of 80° C. and 16 hours using a vacuum dryer, affording a ligand-substituted MXene film. In addition, a plurality of ligand-substituted MXene films having different ligand coverages were obtained as shown in Table 5 below by changing the amount of methylphosphonic acid used in the “(1) Synthesis of ligand-substituted MXene particle”. The ligand coverage was determined in the same manner as in (4) of Example 1-1.

### (Spray Coating Conditions)

Syringe flow rate: 5.0 mL/min
Atomization pressure: 0.5 MPa
Distance between nozzle tip and substrate: 15 cm
Sweep speed: 15 cm/s
Stage temperature: 25° C.

### (5) Conductivity Evaluation of Ligand-Substituted MXene Film

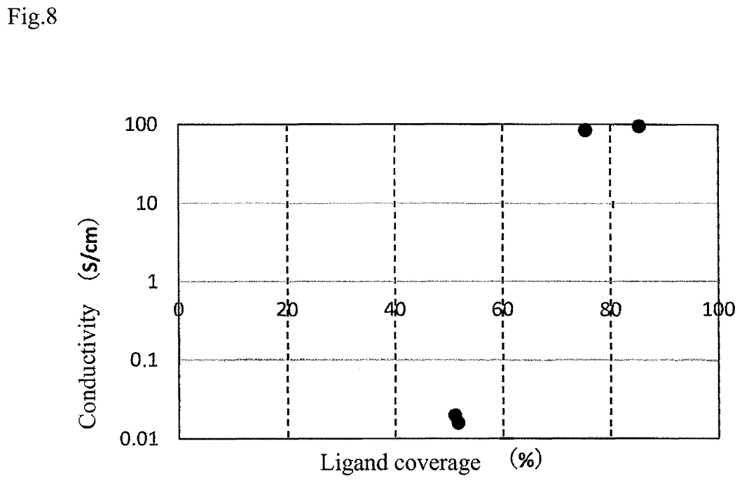

The conductivity (a) of the ligand-substituted MXene film prepared in the above (4) was calculated in accordance with the following formula (1) using surface resistance measurement and film thickness measurement of the ligand-substituted MXene film as described in detail below. The surface resistance of the ligand-substituted MXene film was measured using Loresta (manufactured by Nittoseiko Co., Ltd.: MCP-T370), and the film thickness of the ligand-substituted MXene film was measured using a stylus profilometer (manufactured by ULVAC, Inc.: Dektak 8). The film thickness was measured at three points for one sample, and the average value thereof was used. The conductivity (σ) of the ligand-substituted MXene film calculated using the following formula (1) is shown in Table 5 below together with the ligand coverage. FIG. 8 is a diagram prepared on the basis of the results of Table 5, showing the relationship between the ligand coverage and the conductivity of the ligand-substituted MXene film.

$$σ = 1 / ρ = 1 / ( Rs \cdot t ) \qquad ( 1 )$$

In the formula (1), a [S/cm] means the conductivity of the film, p [Ω·m] means the resistivity, Rs [Ω/square] means the surface resistance, and t [m] means the film thickness.

TABLE 5

| | Amount of methylphosphonic acid (mg) | | | |
|---|---|---|---|---|
| | 31.7 | 38.0 | 57.1 | 63.4 |
| Ligand coverage (%) | 51.0 | 51.6 | 75.4 | 85.3 |
| Surface resistance value | 210000 | 216000 | 44.5 | 41.7 |
| (Ω/square) | | | | |
| Film thickness (μm) | 2.42 | 2.95 | 2.63 | 2.51 |
| Conductivity (S/cm) | 0.020 | 0.016 | 85.3 | 95.6 |

Since all the samples in Table 5 have a ligand coverage of 37.5% or more, or more than 37.5%, it has been separately confirmed that the dispersion stability of all the ligand-substituted MXene particles is 50 hours or more.

From Table 5 above, when the ligand coverage was 75.4% or more, the dispersion stability in ethanol was further improved, and as a result, the film quality of the obtained spray film was improved, and the conductivity was dramatically improved. When the ligand coverage was more than 75.4% and was 85.3%, the dispersion stability in ethanol was further improved, the film quality of the obtained spray film was further improved, and the conductivity, which was 0.016 S/cm when the ligand coverage was 51.6%, was improved to 95.6 S/cm, which was about 6000 times.

### Comparative Example 2

A ligand-substituted MXene particle was prepared by the same procedure as in Comparative Example 1-1 except for using 63.4 mg (0.65 mmol) of methylphosphonic acid (manufactured by Tokyo Chemical Industry Co., Ltd.) in place of dodecylphosphonic acid in (1) of Comparative Example 1-1. Then, washing of the ligand-substituted MXene particle and preparation of a ligand-substituted MXene particle-containing dispersion liquid were conducted in the same manner as in (2) and (3) of Example 2.

Subsequently, film formation was conducted using the ligand-substituted MXene particle-containing dispersion liquid in the same manner as in (4) of Example 2, affording a ligand-substituted MXene film.

For the obtained ligand-substituted MXene film, the conductivity of the ligand-substituted MXene film was evaluated in the same manner as in (5) of Example 2. The ligand coverage was determined in the same manner as in (4) of Example 1-1. As a result, the ligand coverage was 30.5%, the surface resistivity was 3,920,000 Ω/square, the film thickness was 2.55 m, and the conductivity determined from these values was 0.0010 S/cm.

Comparison between Example 2 and Comparative Example 2 shows that the ligand-substituted MXene film (two-dimensional particle-containing film) according to the present embodiment exhibits sufficiently high conductivity. This is considered to be because the ligand-substituted MXene particles aggregated in the ligand-substituted MXene particle-containing dispersion liquid in Comparative Example 2, whereas the ligand-substituted MXene particles were well dispersed in the ligand-substituted MXene particle-containing dispersion liquid in Example 2, and as a result, the film quality of the obtained spray film was improved as described above.

The two-dimensional particles, the two-dimensional particle-containing dispersion liquid, the two-dimensional particle-containing composite, and the two-dimensional particle-containing film of the present disclosure can be utilized for any appropriate application, and can be particularly suitably used, for example, as an electrode in an electric device.

### REFERENCE SIGNS LIST

1a, 1b Layer body (MₘXₙ layer)
3a, 5a, 3b, 5b Modifier or terminal T
7a, 7b MXene layer
10a, 10b MXene particle

1. A two-dimensional particle comprising a single layer or multiple layers, wherein the single layer or the multiple layers each include:
a layer body represented by:
MₘXₙ
wherein M is one or more metal of Group 3, 4, 5, 6, or 7,
X is a carbon atom, a nitrogen atom, or a combination thereof,
n is not less than 1 and not more than 4, and
m is more than n but not more than 5; and
a modifier or terminal T existing on a surface of the layer body, wherein the T is one or more selected from the group consisting of a hydroxy group, a fluorine atom, a chlorine atom, an oxygen atom, and a hydrogen atom,
the two-dimensional particle has a structure in which an M atom of the layer body and a heteroatom of a heteroatom-containing compound having a saturated hydrocarbon group or an unsaturated hydrocarbon group are covalently bonded or ionically bonded together via an oxygen atom derived from a hydroxy group of the layer body, and
a substitution rate of hydroxy groups existing on the surface of the layer body to the structure is 37.5% or more.

2. The two-dimensional particle according to claim 1, wherein the layer body is Ti₃C₂.

3. The two-dimensional particle according to claim 1, wherein the heteroatom-containing compound is selected from a phosphoric acid compound, a nitrogen-containing compound, a silicon-containing compound, or a sulfur-containing compound.

4. The two-dimensional particle according to claim 1, wherein the compound having a saturated hydrocarbon group or an unsaturated hydrocarbon group is a phosphonic acid having a saturated hydrocarbon group or an unsaturated hydrocarbon group.

5. The two-dimensional particle according to claim 4, wherein the phosphonic acid is an alkylphosphonic acid.

6. The two-dimensional particle according to claim 1, wherein the substitution rate is 50% or more.

7. The two-dimensional particle according to claim 1, wherein the substitution rate is 37.5% to 95%.

8. A two-dimensional particle-containing dispersion liquid comprising:
the two-dimensional particle according to claim 1; and
an organic dispersion medium.

9. The two-dimensional particle-containing dispersion liquid according to claim 8,
wherein the organic dispersion medium is one or more selected from the group consisting of ethanol, 2-propanol, and 1-hexanol.

10. A two-dimensional particle-containing composite comprising:
the two-dimensional particle-containing dispersion liquid according to claim 8; and
a polymeric material.

11. The two-dimensional particle-containing composite according to claim 10, wherein the polymeric material is selected from polystyrene, polyurethane, nylon, water-soluble urethane, acrylic polymer, polyethylene glycol, carboxymethyl cellulose, alginic acid polymer, polyether, polyvinyl alcohol, water-soluble polyester, or dicarboxylated polysaccharide.

12. The two-dimensional particle-containing composite according to claim 10, wherein a proportion of the polymeric material in the two-dimensional particle-containing composite is not less than 0.01% by mass and not more than 50% by mass.

13. A two-dimensional particle-containing film comprising the two-dimensional particle according to claim 1, and wherein the substitution rate is 75.4% or more.

14. A method for producing a two-dimensional particle, the method comprising:
(a) preparing a precursor particle comprising a single layer or multiple layers, wherein the single layer or plural layers each include:
a layer body represented by the following formula:
MₘXₙ
wherein M is one or more metal of Group 3, 4, 5, 6, or 7,
X is a carbon atom, a nitrogen atom, or a combination thereof,
n is not less than 1 and not more than 4, and
m is more than n but not more than 5; and
a modifier or terminal T existing on a surface of the layer body, wherein the T is one or more selected from the group consisting of a hydroxy group, a fluorine atom, a chlorine atom, an oxygen atom, and a hydrogen atom, and comprises at least a hydroxy group;
(b) preparing an aqueous dispersion liquid comprising the precursor particle, and a compound-containing organic solution wherein a heteroatom-containing compound having a saturated hydrocarbon group or an unsaturated hydrocarbon group is dissolved in an organic solvent compatible with the aqueous dispersion liquid; and
(c) mixing and stirring the aqueous dispersion liquid to obtain a structure in which an M atom of the layer body and a heteroatom of the heteroatom-containing compound having the saturated hydrocarbon group or the unsaturated hydrocarbon group are covalently bonded or ionically bonded together via an oxygen atom derived from a hydroxy group of the layer body.

15. The method for producing a two-dimensional particle according to claim 14, wherein the aqueous dispersion liquid comprising the precursor particle has a pH in a range of 6 to 8.

16. The method for producing a two-dimensional particle according to claim 14, wherein the organic solvent is one or more selected from the group consisting of ethanol, 2-propanol, ethylene glycol, methanol, acetone, acetonitrile, DMF, NMF, DMSO, and NMP.

17. The method for producing a two-dimensional particle according to claim 14, wherein the mixing and stirring is conducted until a substitution rate of the hydroxy groups existing on the surface of the layer body to the structure is 37.5% or more.

18. The method for producing a two-dimensional particle according to claim 14, wherein the mixing and stirring is conducted until a substitution rate of the hydroxy groups existing on the surface of the layer body to the structure is 50% or more.

19. The method for producing a two-dimensional particle according to claim 14, wherein the mixing and stirring is conducted until a substitution rate of the hydroxy groups existing on the surface of the layer body to the structure is 37.5% to 95%.
